(19) United States
(12) Patent Application Publication
(10) Pub. No.: US 2025/0018740 A1
(43) Pub. Date: Jan. 16, 2025

(54) A METHOD OF MANUFACTURING A SECURITY SHEET AND A SECURITY SHEET

(71) Applicant: De La Rue International Limited, Basingstoke, Hampshire (GB)

(72) Inventors: Annalise Martins, Basingstoke, Hampshire (GB); Simon Quainton, Basingstoke, Hampshire (GB); Christoph Husmann, Basingstoke, Hampshire (GB)

(73) Assignee: De La Rue International Limited, Basingstoke, Hampshire (GB)

(21) Appl. No.: 18/710,761

(22) PCT Filed: Nov. 22, 2022
(86) PCT No.: PCT/EP2022/082761

§ 371 Date: May 16, 2024

(30) Foreign Application Priority Data
Nov. 22, 2021 (GB) 2116783.8

(51) Int. Cl. B42D 25/41; B41M 3/14; B41M 5/24; B42D 25/23; B42D 25/24; B42D 25/351

(52) U.S. Cl. CPC B42D 25/41; B41M 3/14; B41M 5/24; B42D 25/23; B42D 25/351; B42D 25/24

(57) ABSTRACT

The present disclosure relates to a method of manufacturing a security sheet (45) comprising a plastic substrate (20). The plastic substrate comprises opposing first and second outer surfaces (21, 22), a first concealing region (25) extending between the first and second outer surfaces and a laser markable region (29) at least partially located between the first concealing region and the second outer surface. Laser radiation (36) is directed from the first outer surface, through the first concealing region and onto the laser markable region to form at least one data element (40) in the laser markable region such that the at least one data element is hidden from view by the first concealing region when the first outer surface is viewed by the naked eye in reflected light.

### TECHNICAL FIELD

The present invention is directed towards a method of manufacturing a security sheet and a security sheet.

### BACKGROUND

Security documents commonly comprise one or more security sheets on which information is provided. Exemplary security documents include cards, such as identity cards and driving licences, and booklets, such as passports, passbooks, identification documents, certificates, licences, cheque books and the like. The security sheet may be formed from a sheet comprising a plastic, which is typically polycarbonate. Plastic sheets are more durable than fibrous substrate security sheets and are resistant to delamination by a counterfeiter. During manufacture several thin plastic layers are laid over one another and laminated together, thereby forming a thicker plastic sheet.

The plastic security sheet usually contains personal data in the form of laser markings located within the thickness of the security sheet. A plastic security sheet may also comprise various other security features, such as antennas, UV responsive arrangements, optically variable features, windowed or transparent features, laser-perforations, and tactile features. Forgers are known to adapt such security sheets by changing the personal data whilst maintaining the other security features. As the personal data is usually located beneath the surfaces of the security sheet, the forger will often try to abrade the material from one of the surfaces to reach the personal data. After changing the personal data the forger may add further plastic over the abraded area to hide the adaptation.

### SUMMARY

An object of the present invention is to provide a method of manufacturing an improved security sheet with data that is more difficult for a forger to adapt and/or with an arrangement that increases the detectability of any forgery. A further object is to provide an improved hidden security feature that is hard to replicate and easy for a document inspector and/or holder to recognise.

The present invention therefore provides a method of manufacturing a security sheet comprising a plastic substrate, wherein: the plastic substrate comprises opposing first and second outer surfaces, a first concealing region extending between the first and second outer surfaces and a laser markable region at least partially located between the first concealing region and the second outer surface; and the method comprises directing a laser radiation from the first outer surface, through the first concealing region and onto the laser markable region to form at least one data element in the laser markable region. The laser radiation may form the at least one data element in the laser markable region such that the at least one data element is hidden from view by the first concealing region when the first outer surface is viewed by the naked eye in reflected light.

The plastic substrate may comprise a second concealing region extending between the laser markable region and the second outer surface. The at least one data element may be hidden from view by the second concealing region when the second outer surface is viewed by the naked eye in reflected light.

The present invention further provides a security sheet comprising a plastic substrate, the plastic substrate comprising: opposing first and second outer surfaces; first and second concealing regions extending between the first and second outer surfaces; a laser markable region at least partially located between the first and second concealing regions; and at least one data element, which may be laser marked, ablated or engraved, located in the laser markable region and between the first and second concealing regions. The at least one data element may be hidden from view by the first concealing region when the first outer surface is viewed by the naked eye in reflected light and may be hidden from view by the second concealing region when the second outer surface is viewed by the naked eye in reflected light.

The security sheet provides a significant increase in security and counterfeit protection, particularly by increasing the difficulty of tampering and replication. The security sheet is difficult to tamper with as a forger would need to remove sections of the plastic substrate, such as the first and/or second concealing regions or other transparent or concealing regions, to access the at least one data element for tampering. This increases the difficulty of tampering and increases the likelihood of detection of tampering due to the identification of the plastic replaced over the tampered-with data element by the forger.

The at least one data element is a hidden security feature that is not visible when the security sheet is viewed under normal circumstances (i.e. in reflected light) by a document inspector or the public. The at least one data element may be visible to the naked eye when the first and/or second outer surface is viewed in transmitted light. Thus the at least one data element may be a public security feature as it can be easily revealed by a document inspector or holder in transmitted light. This effect is unexpected as normally data elements, particularly personalised information, is not concealed within the laminate structure.

Furthermore, the at least one data element, usually in the form of personal or non-variable data, can be applied by the laser by the issuing authority to a fully laminated plastic substrate. Hence the issuing authority itself can create a fully embedded, hidden, and public security feature.

The method may comprise forming the plastic substrate from a plurality of layers. Forming the plastic substrate may comprise arranging the layers over one another and laminating (i.e. attaching or bonding) the layers together. Each of the first and second concealing region may be formed from at least one substantially opaque layer and the laser markable region may be formed from at least one laser markable layer. The lamination may comprise the application of heat and/or pressure and may be similar to that of WO-A-2017/060684, WO-A-2017/060688, WO-A-2015/104011, U.S. Pat. No. 6,669,813 and US-A-2011/0226408, although any suitable method may be implemented.

In the present disclosure “viewed by the naked eye” refers to a human eye viewing the security sheet unaided and without the use of optical instruments or machines. In the present disclosure “viewed in reflected light” refers to viewing the security sheet from the same side as the light source and “viewed in transmitted light” refers to viewing the opposing side of the security sheet to the light source. The reflected or transmitted light may be visible light, which has a wavelength within the visible spectrum (i.e. approximately 400 to 750 nm), as opposed to non-visible light, which has a wavelength outside of the visible spectrum (e.g. ultraviolet or infrared light).

In the present disclosure the term “hidden from view” means that the at least one data element in the laser markable region is substantially not visible, distinguishable, or understandable either when the first outer surface is viewed in reflected light by the naked eye or, if the second concealing region is present, when the second outer surface is viewed in reflected light by the naked eye. In effect the first or second concealing region substantially blocks reflected light incident upon the first or second outer surface from reaching the at least one data element. Such viewing is particularly in reflected light only (i.e. substantially without any transmitted light), for example when the security sheet is placed against a substantially opaque object that does not substantially transmit light therethrough (e.g. a passport cover or table).

In the present disclosure the term “concealing region” refers to a region that conceals or hides the at least one data element from view when the respective outer surface is viewed by the naked eye in reflected light. The concealing region(s) may therefore be a substantially opaque region(s). The concealing region(s) may be substantially opaque to visible light and may be substantially transparent to the laser radiation (for example the laser radiation may be non-visible light).

The concealing region may be formed from a single concealing layer located between the laser markable region and the respective outer surface or by a plurality of substantially concealing layers overlapping one another over the laser markable region between the laser markable region and the respective outer surface. The optical density of the single concealing layer or the optical density of the combination of the overlying concealing layers is configured to hide the at least one data element in reflected light and allow it to be visualised in transmitted light. The or each concealing layer may be a substantially opaque layer, which may be formed from plastic, such as white plastic.

The optical density of the or each concealing region(s) is preferably at least about 0.4, more preferably at least about 0.5 and yet more preferably at least about 0.6. These measurements may be determined from the layer(s) forming the concealing region(s) prior to lamination to form the plastic substrate. Such a minimum value ensures that the concealing region(s) has/have a sufficiently high optical density to hide the at least one data element in reflected light by blocking transmission of the reflected light therethrough.

The at least one data element is visible in transmission by having a contrasting or different opacity or optical density to a surrounding region of the laser markable region. The surrounding region may be the area of the laser markable region adjacent to, surrounding or bounding the at least one data element. The laser markable regions may comprise multiple different surrounding regions surrounding or bounding different data elements. The at least one data element may comprise at least one negative data element, the area of which appears lighter (i.e. having a lower optical density) than the darker surrounding region, and/or at least one positive data element, the area of which appears darker (i.e. having a higher optical density) than the lighter surrounding region.

The optical density of the security sheet when measured through the lighter at least one data element and/or surrounding region from the first outer surface to the second outer surface is preferably less than about 2.7, more preferably less than about 2.5 and yet more preferably less than about 2.2. These measurements may be determined from the security sheet once the at least one data element has been formed (and thus post lamination) and by measuring orthogonally to the first or second outer surface over the lighter at least one data element and/or surrounding region. Such a maximum value ensures that the lighter at least one data element and/or surrounding region has an optical density that is sufficiently low for the lighter region to be visible in transmission.

The difference in optical densities of the security sheet between the lighter and darker regions of at least one data element and surrounding region(s), when measured therethrough from the first outer surface to the second outer surface, is preferably at least about 1.5, more preferably at least about 1.6 and yet more preferably at least about 1.7. These measurements may be determined from the security sheet once the at least one data element has been formed (and thus post lamination) and by measuring orthogonally to the first or second outer surface over each of the lighter and darker at least one data element and surrounding region(s). Such a minimum difference value ensures that there is sufficient contrast in transmission between the at least one data element and surrounding region(s).

The concealing region(s) may have such an optical density both before and after the application of the laser radiation to the first concealing region. A suitable optical density can be obtained by selecting a suitable material for the layer(s) forming the concealing region(s) and selecting a suitable thickness thereof.

As is known in the art, “optical density” is a measure of the transmittance through an optical medium. Optical density, also known as transmission density, equals the log to the base 10 of the reciprocal of the transmittance as set out below, in which OD is the optical density, I₀ is the incident optical intensity (optical intensity hitting the material) and I is the transmitted optical intensity (optical intensity transmitted by the material/film:

$$O D = {log}_{10} ( {l}_{0} / l )$$

The laser radiation changes the optical density of the laser markable region to form the at least one data element. In particular, the laser radiation may mark, ablate or engrave the laser markable region, which may thereby change the optical density of the laser markable region locally, to form the at least one data element. Depending upon the composition of the laser markable region, the laser radiation may selectively remove the laser markable region (i.e. fully ablate), partially remove the laser markable region to reduce its thickness (i.e. partially ablate to a non-zero thickness), change the material properties of the laser markable region (e.g. by melting or burning) and/or the like. During ablation or engraving, such as if the laser markable region comprises metal, the laser radiation may ablate the laser markable region by removing material through a portion or the entire thickness of the laser markable region. During marking, such as if the laser markable region comprises plastic or an ink layer, the laser radiation may change the material properties of the laser markable region to adjust its optical density. For example, the laser radiation may mark the laser markable region by carbonisation, melting or by changing its colour and/or opacity.

The at least one data element, whether positive or negative, may be formed by application of the laser radiation within the perimeter or area of the at least one data element. Hence the laser radiation directly forms the at least one data element. Alternatively, the at least one data element, whether negative or positive, may be formed by the application of the laser radiation around the perimeter or area of the at least one data element. For example, if the data element shows a shape of a country, it may be formed by the altering the optical density of the laser markable region within the perimeter of the country. This forms a negative data element if ablating a metal layer or a positive data element if darkening a plastic layer through laser marking. Alternatively, the data element may be formed by altering the optical density of the surrounding region around the perimeter of the country. This forms a positive data element if ablating a metal layer or a negative data element if darkening a plastic layer through laser marking.

The laser radiation may not substantially ablate, engrave or mark the first and/or second concealing region or the rest of the plastic substrate when forming the at least one data element. In particular, the laser radiation does not form any apertures or the like through the first and/or second concealing region (or any overlying transparent region(s)). Therefore, the at least one data element may not also be formed on the first and/or second concealing region and/or any marking in the concealing region(s) may not substantially be visible when the first and/or second outer surface is viewed by the naked eye in reflected light. It will be appreciated that some marking, ablation or engraving may occur in the first and/or second concealing region and such marking, ablation or engraving may be visible when viewed microscopically. However, the first and/or second concealing region may still hide the at least one data element from view when the first and/or second outer surface is viewed by the naked eye in reflected light. Hence the laser radiation does not substantially change the optical density of the first concealing region or the laser radiation changes the optical density of the first concealing region by less than the laser radiation changes the optical density of the laser markable region when forming the at least one data element. Thus in the security sheet the optical density of the laser markable region forming the at least one data element is less than the optical density of the overlying concealing region(s).

The laser radiation may be of any suitable type for forming the at least one data element in the laser markable region, such as by marking, ablating, engraving or the like. The wavelength and power of the laser radiation may be selected, as is known in the art, based upon the construction of the plastic substrate and with the aim of producing the at least one data element in the laser markable region, particularly without substantially ablating, engraving or marking the first and/or second concealing regions. Considerations include the type of laser markable region and the thickness and/or materials of the plastic substrate. Generally the wavelength of the laser radiation is in the range from approximately 240 nm to approximately 11000 nm. For example, the laser may be a DPSS (diode pulsed solid state) laser emitting laser radiation at a wavelength of approximately 532 nm, an Nd-YAG (neodymium-doped yttrium aluminium garnet) pulse laser having a wavelength of approximately 1064 nm, a fibre laser, or a carbon dioxide continuous or COa laser with a wavelength of approximately 10600 nm.

The at least one data element may be any element conveying information. The at least one data element may comprise at least one indicium, symbol, logo, image, alphanumeric character and/or machine-readable code and may form personal and/or non-variable data. In the present disclosure the “personal data”, also known as variable data, relates to the holder of the security sheet or security document. Such personal data may comprise a name, date of birth, portrait, nationality, address and/or machine-readable data relating to the holder. In the present disclosure “non-variable data” represents generic information which is typically present in several security sheets issued by an issuing authority. For example, the non-variable data may indicate the issuing authority of the security sheet, or it may be in the form of a pattern or image, such as a crest or country shape

The present disclosure further provides a method of manufacturing a plurality of security sheets, wherein each security sheet is formed as disclosed herein and further wherein the data elements of each security sheet form different personal data. The present disclosure further provides a plurality of security sheets as disclosed herein wherein the data elements of each security sheet form different personal data.

The method may further comprise applying at least one further data element, preferably outside of the laser markable region, and the security sheet may comprise at least one further data element, preferably outside of the laser markable region.

The personal and/or non-variable data may comprise the at least one data element and at least one further data element. The at least one further data element may be visible and intelligible to the naked eye when the first outer surface is viewed in reflected light. The at least one further data element may comprise at least one of printed ink, laser marking, a security thread, a hologram, a foil, a demetallized structure, a biometric data storage device and the like. The at least one further data element may also comprise secret data, such as that only visible under certain lighting conditions (e.g. ultraviolet light) or the like.

In a particular embodiment, the at least one data element forms personal data that is repeated elsewhere on the security sheet as at least one further data element. For instance, the at least one data element may form a portrait which is visible only in transmission whilst the at least one further data element may form a portrait which is visible in reflected light. As a result, when viewed in transmitted and reflected light, the personal data of the at least one further data element can be verified against the at least one data element.

The laser markable region and at least one laser markable layer may comprise a material that can locally change in optical density under the application of laser radiation and when underneath a, or when between, concealing region(s). The laser markable region may be transparent or opaque, depending upon its composition and the method by which it is marked.

The laser markable region and at least one laser markable layer may comprise a metal layer, which is preferably vapour deposited, and the laser radiation may ablate or mark the metal layer. The metal layer comprises, for example, aluminium, copper, silver, gold, tin and/or indium. The thickness of the metal layer may be at least about 20 nm or preferably at least about 50 nm or more preferably at least about 100 nm.

The metal layer may be a solid metal layer prior to application of the laser radiation. However, to improve bonding of layers forming the plastic substrate, the metal layer may comprise a series of lines or line work with the plastic substrate extending through apertures or gaps in the metal layer. However, the apertures or gaps may be sufficiently small that they are substantially not visible to the naked eye when the first outer surface is viewed in reflected light. The metal layer may be located on and/or at least partially embedded within another layer, such as a plastic layer, which may act as a carrier layer for the metal layer during lamination.

The laser markable region and at least one laser markable layer may comprise plastic and the laser radiation may ablate or mark the plastic. The laser markable region may be opaque or transparent. The laser markable region may be markable, ablatable or engravable by absorbing laser radiation to increase the temperature of localised areas and form a permanent discolouration, such as by melting, ablation, or carbonation. The discolouration typically results in a black mark but bleaching (i.e. forming a light mark) is an alternative. The plastic of the laser markable region may comprise a laser markable additive for marking by the laser radiation. The laser markable additive may comprise any suitable additive, such as at least one of titanium dioxide, mica, carbon, tin or antimony-based oxides, copper-based oxides, molybdenum-based oxides and/or bismuth-based oxides.

The laser markable region and at least one laser markable layer may comprise an ink layer and the laser radiation may mark, ablate or engrave the ink layer. The ink layer may be transparent or may comprise an opacifying ink. The ink layer may be applied to a plastic layer prior to lamination to form the plastic substrate. The inks for the ink layer may comprise optically variable inks, inks comprising mixtures of optically variable pigments and coloured pigments, metallic inks (such as those disclosed in EP-A-2639077A) and/or reflective inks. The inks may be printed using any suitable method, such as screen printing, gravure and so on. Optically variable pigments having a colour shift between two distinct colours, with the colour shift being dependent on the viewing angle, are well known. The production of these pigments, their use and their characteristic features are described in, inter-alia, WO-A-2010139930, U.S. Pat. Nos. 4,434,010, 5,059,245, 5,084,351, U.S. Pat. Nos. 5,135,812, 5,171,363, 5,571,624, EP-A-0341002, EP-A-0736073, EP-A-668329, EP-A-0741170 and EP-A-1114102.

The laser markable region may extend across only part of the plastic substrate and may extend across less than 50% or less than 25% of the area of the first or second outer surface. Thus the laser markable region and at least one laser markable layer may form a discrete area within the plastic substrate and layers prior to lamination. The laser markable region may also extend across the entire data sheet, including through windows if present. Alternatively, the plastic substrate may comprise a plurality of discrete laser markable regions and at least one data element may be formed in each discrete laser markable region.

The outer perimeter of the laser markable region may form at least one motif which is distinguishable against the rest of the plastic substrate when the first or second outer surface is viewed by the naked eye in transmitted light. The at least one motif may form at least part of the personal data or non-variable data. The at least one motif may form a, preferably complex, image or design distinguishable against the background region. The or each at least one motif may convey recognisable information to a reader and may form at least one of a pattern, symbol, flag, emblem, flower, logo, drawing, letter, pictogram, illustration, alphanumeric character, grapheme, national emblem, coat of arm, name, photograph, serial number, indicium, and code.

The plastic substrate may comprise at least one transparent region located between the first and second outer surfaces and the at least one transparent region may be formed from at least one transparent plastic layer. In a similar manner to the concealing regions, the at least one transparent region may extend entirely between the edges of the plastic substrate. The plastic substrate may comprise a first transparent region between the first outer surface and the first concealing region, a second transparent region between the first and second concealing regions and/or a third transparent region between the second concealing region and the second outer surface. If the concealing region(s) comprises a plurality of concealing layers, one or more transparent layers may be located between the concealing layers. The laser markable region may be located at least partially in the second transparent region or between the second transparent region and the first or second concealing region.

The plastic substrate may further comprise at least one print layer applied to and/or within at least one transparent or concealing region. In particular, the at least one print layer may be applied, for example by offset printing, to at least one transparent or opaque layer prior to lamination to form the plastic substrate. The print layer may form graphic images, at least one visible data element and/or at least one secret data element.

The plastic substrate may also comprise at least one transparent laser markable layer. WO2021099248A1 discloses suitable embodiments of the at least one transparent laser markable layer, which may be a transparent plastic film layer with an additive which absorbs the laser radiation to form a mark or alternatively a transparent coating with the additive applied to the transparent film.

The laser radiation may be directed from the first outer surface, through the first concealing region and onto the laser markable region to form at least one data element in the laser markable region and simultaneously to form at least one further or registered data element in the plastic substrate in register with or overlying the at least one data element. At least one transparent region, concealing region, print layer and/or laser markable layer may therefore be laser markable (i.e. depending upon their material properties and the selection of a suitable laser power and wavelength) such that at least one registered data element may be marked therein, the at least one registered data element being visible to the naked eye in reflected light at the first outer surface. The resulting at least one registered data element and at least one data element may be in perfect registration with one another. Hence the difficulty of forgery is increased as both elements would require adaptation to produce a forgery.

The laser radiation may also form a tactile feature on the first outer surface. The laser radiation may be directed from the first outer surface, through the first concealing region and onto the laser markable region to form at least one data element in the laser markable region and simultaneously to form a tactile feature in register with or overlying the at least one data element. The tactile feature may comprise at least one raised or depressed region protruding from or extending into the surrounding first outer surface and detectable by human touch. In particular, the height or depth of at least one raised or depressed region relative to the adjacent region of the first outer surface may be at least about 10 microns, at least about 30 microns or at least about 50 microns.

At least one guide element may also be formed in the plastic substrate to indicate the location of the laser markable region and/or at least one data element. The at least one guide element may comprise at least one further data element or tactile feature formed as discussed above. The at least one guide element may cover part of the laser markable region and/or at least one data element so that the user can identify the location of the laser markable region and/or at least one data element. For example, a plurality of guide elements may be located around the perimeter of the laser markable region and/or at least one data element, thereby identifying their location.

The plastic substrate may include a biometric storage device therein, such as an RFID device comprising an antenna connected to a chip module for storing biometric data thereon. Data relating to the identity of the security document created from the plastic substrate may be stored on the biometric storage device.

The plastic substrate may comprise at least one window, which may be a full window or a half window, comprise a transparent window region extending through at least the first concealing region. A full window may comprise a transparent window region extending between the first and second outer surfaces and through the first and second concealing regions such that the plastic substrate is see-through at the full window. A half window may comprise a transparent window region extending through the first concealing region such that the second concealing region is visible in the half window from the first outer surface in reflected light or extending through the second concealing region such that the first concealing region is visible in the half window from the second outer surface in reflected light.

The at least one window and transparent window region may be formed by forming or cutting an aperture in an opaque plastic layer and allowing transparent material from adjacent transparent plastic layers to flow into the aperture during lamination or may be formed from a transparent insert located in a correspondingly shaped aperture in an opaque plastic layer prior to formation of the plastic substrate. The windows may be formed as described in WO-A-2017/060684 and WO-A-2017/060688.

The laser markable region may be located adjacent to, extend across and/or at least partially surround at least one window. For instance, the transparent insert may be located adjacent or through the at least one laser markable layer prior to lamination. The at least one data element may be located adjacent to the at least one window. At least one further data element, which may be a visible or secret element, may be formed in the at least one window, such as adjacent to the at least one data element. The at least one data element (i.e. hidden by the concealing region(s)) adjacent the at least one window and at least one further data element in the at least one window may together at least partially form personal data or non-variable data.

The at least one data element in the laser markable region adjacent to the at least one window may be formed at the same time as the at least one further data element in the at least one window, such as by laser marking, ablating and/or engraving. As a result, they may be registered to one another, increasing the difficult of adaptation by a forger.

The plastic substrate is preferably rigid or at least semi-rigid and may have a substantially non-laminar or unitary structure. The plastic of the plastic substrate, layers and insert may comprise at least one of a thermoplastic polymer, polycarbonate, polybutylene terephthalate, polyester, polyethylene, polypropylene, polyvinyl chloride, a co-polymer comprised of any of the previous thermoplastic polymers and the like. Polycarbonate is particularly suitable due to its high durability, its ease of manufacture and the ease with which security features can be incorporated within it.

Each layer forming the plastic substrate may have a thickness of between approximately 25 microns to approximately 300 microns. The thickness of the plastic substrate, which is the distance between the first and second outer surfaces, is preferably at least approximately 150 μm and more preferably at least approximately 300 μm. In particular, the plastic substrate may be between approximately 300 μm and 1000 μm thick and, for example, may be approximately 800 μm thick.

The plastic substrate and one or more layers may comprise at least one further security device embedded therein or located thereon. Graphical information, colours and/or patterns may be printed on the outer surfaces of the layers prior to or after lamination. The at least one security device may, for example, comprise laser markings, printed ink, holograms, UV responsive features, optically variable features, windowed or transparent features, laser-perforations, and the like. The at least one security device may be visible when viewed in reflected light by virtue of being in transparent region(s). Alternatively the at least one security device may be covert, such as by being in a concealing region, such that it is not visible when viewed in reflected light.

The present disclosure further provides a security document comprising the security sheet. The security document may be a security booklet (e.g. a passport), security card, passbook, identification document, certificate, licence, cheque book or the like. In the case of a security booklet such as a passport, the security document may comprise a flexible attachment layer connecting the security sheet to the rest of the security document, such as visa pages and/or a cover.

### BRIEF DESCRIPTION OF THE DRAWINGS

By way of example only, embodiments of a method of manufacturing a security sheet and a security sheet in accordance with the present invention are now described with reference to, and as shown in, the accompanying drawings, in which:

FIG. 1A is a cross-sectional side elevation of a plurality of layers for forming, in accordance with the present invention, a plastic substrate of a security sheet;

FIG. 1B is a cross-sectional side elevation of a plastic substrate formed from the plurality of layers of FIG. 1A and showing the application of laser radiation in accordance with the method of the present invention;

FIG. 1C is a cross-sectional side elevation of a security sheet formed from the plastic substrate of FIG. 1B and showing the direction of viewing thereof in transmitted light;

FIG. 2A is a plan view of the security sheet of FIG. 1C when viewed in reflected light and showing a section A-A through which FIG. 1C is taken;

FIG. 2B is a plan view of the security sheet of FIG. 1C when viewed in transmitted light and showing the section A-A through which FIG. 1C is taken;

FIG. 3 is a cross-sectional side elevation of a further embodiment of a security sheet formed in accordance with the present invention and comprising a half window; and

FIG. 4 is a cross-sectional side elevation of a further embodiment of a security sheet formed in accordance with the present invention and comprising a half window.

### DETAILED DESCRIPTION

The present invention generally relates to forming a plastic substrate with a first concealing region and a laser markable region therein and subsequently applying at least one data element in the laser markable region using laser radiation applied through the first concealing region.

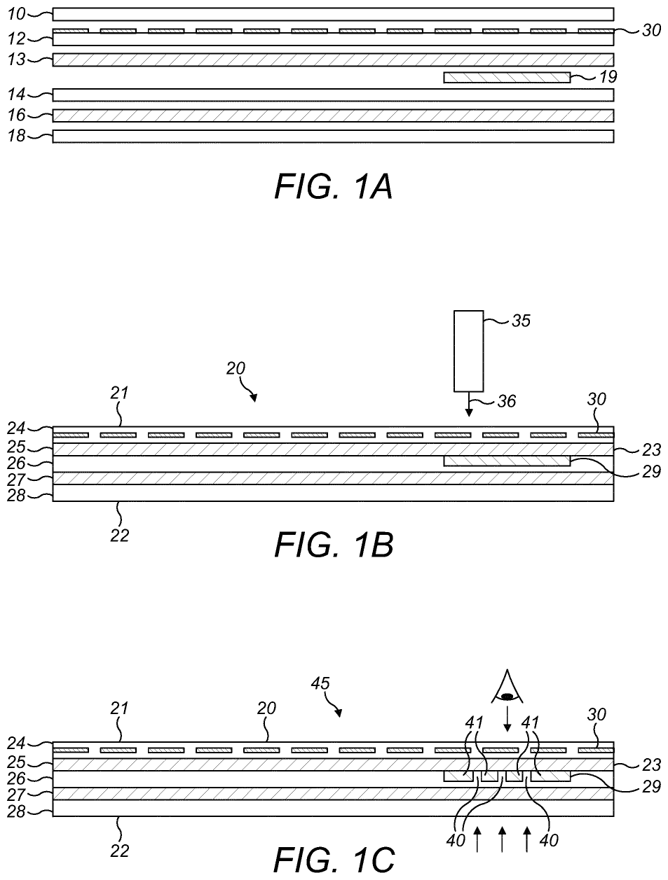

FIG. 1A illustrates schematically a plurality of layers 10, 12, 13, 14, 16, 18, 19 for forming a plastic substrate 20, illustrated in FIG. 1B, in accordance with an embodiment of the present invention. To form the plastic substrate 20, the layers 10, 12, 13, 14, 16, 18, 19 are arranged over one another and subsequently laminated together. The layers 10, 12, 13, 14, 16, 18, 19 may also be formed separately prior to being overlaid upon one another, although some layers, such as layer 19, may be applied to another layer 10, 12, 13, 14, 16, 18 prior to being overlaid upon the other layers 10, 12, 13, 14, 16, 18. They may be overlaid sequentially, but preferably they are mounted on feeding rolls or the like and brought together at substantially the same time as, or just prior to, lamination.

The lamination may be by any known method, such as by the fusing of plastic in the layers 10, 12, 13, 14, 16, 18, 19 via the application of heat and pressure and/or by applying adhesive between the layers 10, 12, 13, 14, 16, 18, 19. After lamination, the resulting unitary plastic mass may be cut into a plurality of smaller plastic substrates 20 for forming security sheets.

The plastic substrate 20 comprises first and second outer surfaces 21, 22, which are substantially flat and planar, and extends across a thickness therebetween. The plastic substrate 20 comprises an outer perimeter 23, which may be formed from the edges of the layers 10, 12, 13, 14, 16, 18, 19. The plastic substrate 20 of the illustrated embodiment comprises a first, second and third transparent region 24, 26, 28, first and second concealing regions 25, 27 and a laser markable region 29. In other embodiments there may be further transparent or concealing regions or one or more of the transparent regions 24, 26, 28 may be omitted.

The first transparent region 24 is located adjacent to and forms the first outer surface 21. The first transparent region 24 is formed from at least one transparent plastic layer 10, 12, which may comprise a transparent layer 10 and/or a transparent print layer 12. The transparent print layer 12 may comprise a print region 30 thereon, which in the plastic substrate 20 may be located within the first transparent region 24.

The first concealing region 25 is located adjacent to the first transparent region 24. The first concealing region 25 is formed from at least one first opaque layer 13. If the first transparent region 24 is not present, the first concealing region 25 may form the first outer surface 21.

The second transparent region 26 is located adjacent to the first concealing region 25 on the opposing side thereof to the first transparent region 24. The second transparent region 26 and is formed from at least one transparent plastic layer 14.

The second concealing region 27 is located adjacent to the second transparent region 26 on the opposing side thereof to the first concealing region 25. The second concealing region 27 is formed from at least one second opaque layer 16. If the second transparent region 26 is not present, the second concealing region 27 may form the second outer surface 22.

The third transparent region 28 is located adjacent to the second concealing region 27 and forms the second outer surface 22. The third transparent region 28 is formed from at least one transparent plastic layer 18.

The laser markable region 29 is located on the opposing side of the first concealing region 25 to the first outer surface 21 and between the first and second concealing regions 25, 27. The laser markable region 29 is formed from a laser markable layer 19, which in the illustrated embodiment forms a discrete element separated from the outer perimeter 23 of the plastic substrate 20. The laser markable region 29 may be formed between the second transparent region 26 and the first concealing region 25 as illustrated. Alternatively it may be formed within the second transparent region 26, between the second transparent region 26 and the second concealing region 27 or, if no second transparent region 26 is present, directly between the first and second concealing regions 25, 27. The laser markable layer 19 may be applied to an adjacent layer 13, 14 prior to lamination and may not be self-supporting.

As illustrated in FIG. 1B, in the method of the present invention a laser 35 is arranged to direct laser radiation 36 through the first outer surface 21. The laser 35 emits the laser radiation 36 along a direction normal to the first outer surface 21. The laser radiation 36 is directed from the first outer surface 21 and through the first concealing region 25 onto the laser markable region 29. In the illustrated embodiment the laser is also directed through the first transparent region 24 and, depending upon the location of the laser markable region 29, may also be directed through the second transparent region 26 (and others if present).

The laser radiation 36 forms at least one data element 40 in the laser markable region 29, as shown in FIG. 1C, with a surrounding region 41 of the laser markable region 29 extending around the at least one data element 40. In the illustrated embodiment the laser markable region 29 comprises a metal layer and the laser radiation 36 ablates and removes the metal layer to form the at least one data element 40, with the remaining metal layer forming the surrounding region 41. The direction of the laser radiation 36 and/or the location of the laser 35 relative to the plastic substrate 20 is varied during the marking such that the discrete shape of the at least one data element 40 is formed.

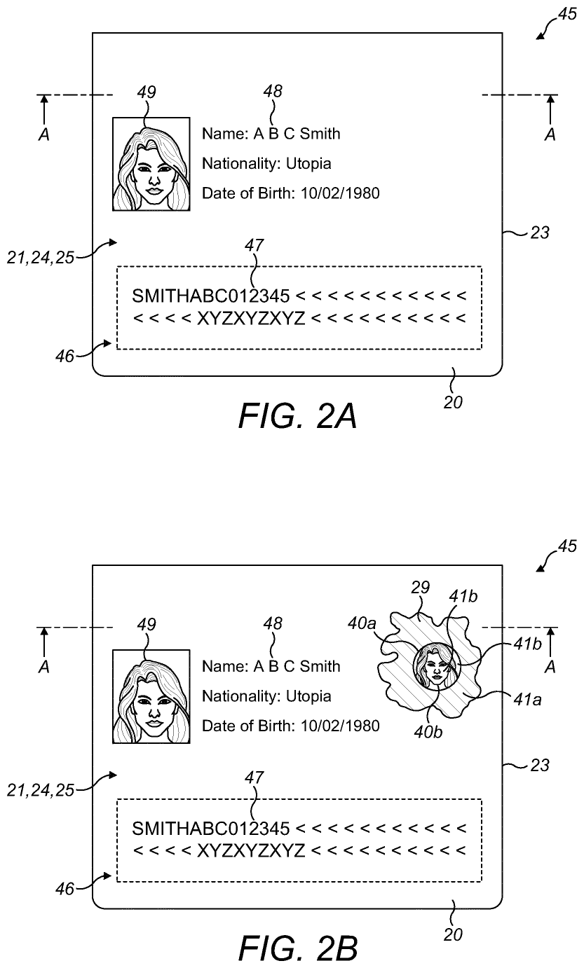

FIGS. 2A and 2B illustrated a security sheet 45 comprising the plastic substrate 20. FIG. 2A shows the security sheet 45 when the first outer surface 21 is viewed in reflected light, i.e. when the naked eye and the visible light source are both on the side of the first outer surface 21 of the security sheet 45. When viewed in these conditions, the at least one data element 40 is substantially not visible to the naked eye. Instead, the first concealing region 25 is sufficiently opaque to hide the data element 40 from view by blocking light from being incident upon the laser markable region 29. Thus the at least one data element 40 is not immediately visible to a document inspector or the holder.

FIG. 2B shows the security sheet 45 when the first outer surface 21 is viewed in transmitted light. As illustrated in FIG. 1C, the visible light source directs light through the second outer surface 22 whilst the naked eye viewed the first outer surface 21. When viewed in these conditions, the data element 40 (which comprises a portrait of the document holder) is visible to the naked eye in contrast to the surrounding region 41. The plastic substrate 20, particularly due to the opacity of the first and second concealing regions 25, 27 (and any other concealing regions overlying the at least one data element 40), allows sufficient transmitted light through it such that the data element 40 is highlighted. Thus the data element 40 can be viewed and verified relatively easily by a document inspector or the holder.

In the illustrated embodiment, the data element 40 comprises two levels having positive and negative sections. At the first level, the metal layer comprises a darker surrounding region 41a forming a circle 40a of the data element 40, with the area within the circle 40a predominantly comprising a surrounding region 41b that is lighter than the darker surrounding region 41a (i.e. so that the first level is a generally negative section). The second level of the data element 40 is formed within this circle 40a, in which the ablated surrounding region 41b comprises a lighter area and is crossed by unablated lines 41b forming the portrait. These lines 41b form a positive section of the second level in contrast to the lighter surrounding region 41b. In addition or alternatively, the detail of the lines 41b may be formed by varying the thickness of the material removed during ablation to vary the optical density in the data element 40.

In addition, the outer perimeter of the laser markable region 29 forms at least one motif forming non-variable data, in this case the shape of a fictional country, thereby making the security sheet 45 yet harder to forge.

The security sheet 45 also includes personal data 46 comprising further data elements 47, 48, 49 in the form of a machine-readable code 47, text 48 (which also forms some non-variable data) and a portrait 49. The data element 40 forms the same portrait as the portrait 49 of the further data elements 47, 48, 49. As a result, a document inspector can check that the portraits have not been tampered with by verifying them against each other. This adds additional burden to an attempted forgery and increases the likelihood of any forgery being identifiable. The further data elements 47, 48, 49 may be formed in any of the layers 10, 12, 13, 30, such as by laser marking.

In the embodiment of FIGS. 1A to 2B, the power and wavelength of the laser radiation 36 is selected to not leave any marking visible to the naked eye above or below the laser markable region 29. Therefore, the information conveyed by the data element 40 can only be read in transmitted light. The power and wavelength selected is based upon the composition of the plastic substrate 20, particularly the composition and thickness of the regions 24, 25, 26, 27, 28. A particular example is set out below.

In this example, the plastic substrate 20 comprised the layers 10, 13, 14, 16, 18, 19 and regions 24, 25, 26, 27, 28 constructed as shown in FIGS. 1A to 1C without the transparent print layer 12 or print region 30. The compositions and thicknesses of the constituent layers 10, 13, 14, 16, 18, 19 are set out below. The plastic substrate 20 was formed by laminating the layers 10, 13, 14, 16, 18, 19, as is well known in the art, for example by the application of heat at approximately 180° C. and pressure at approximately 8 MPa. Subsequently, to form a data element 40 in the shape of a portrait, the metal layer 19 was ablated using laser radiation 36 from a diode pump solid state (DPSS) laser with a wavelength of 1064 nm, a current of 21.5 A, a frequency of 9000 Hz and a speed of 200 mm/s.

The optical density of the security sheet 45 when measured from the first outer surface 21, 22 through the ablated surrounding regions 41b of the metal layer 19 was 1.45. The optical density of the security sheet 45 when measured from the first outer surface 21, 22 through the unablated surrounding region 41a was 3.2. The laser ablated portrait was not visible to the naked eye when the first outer surface 21 was view from at least 10 cm away when in reflected light and when the plastic substrate 20 was placed against a completely opaque table surface. However, when held up to a room ceiling light, the laser ablated portrait became clearly visible to the naked eye, by virtue of the difference in optical density of 1.75 between the ablated and unablated areas.

| Layer | Composition | Thickness | |
|---|---|---|---|
| Transparent laser | Transparent polycarbonate | 75 | μm |
| markable layer 10 | | | |
| First opaque layer 13 | White polycarbonate, | 30 | μm |
| | Optical density = 0.7 | | |
| Transparent layer 14 | Transparent polycarbonate | 50 | μm |
| Second opaque layer 16 | White polycarbonate, | 30 | μm |
| | Optical density = 0.7 | | |
| Transparent layer 18 | Transparent polycarbonate | 75 | μm |
| Laser markable layer 19 | Aluminium | 100 | nm |

In alternative embodiments, the laser power can be increased such that at least one further data element is produced over the at least one data element 40. The at least one further data element may be produced in the first and/or second transparent region 24, such as by marking the transparent laser layer 10, the print of the transparent print layer 12 and/or the print of the laser printed transparent layer 17. The at least one further data element may therefore be in perfect registration with the at least one data element 40. Whilst the at least one data element 40 may not be easily distinguishable from the at least one further data element when viewed in transmitted light, if one is altered by a forger then any such alteration would be visible as a mismatch between them.

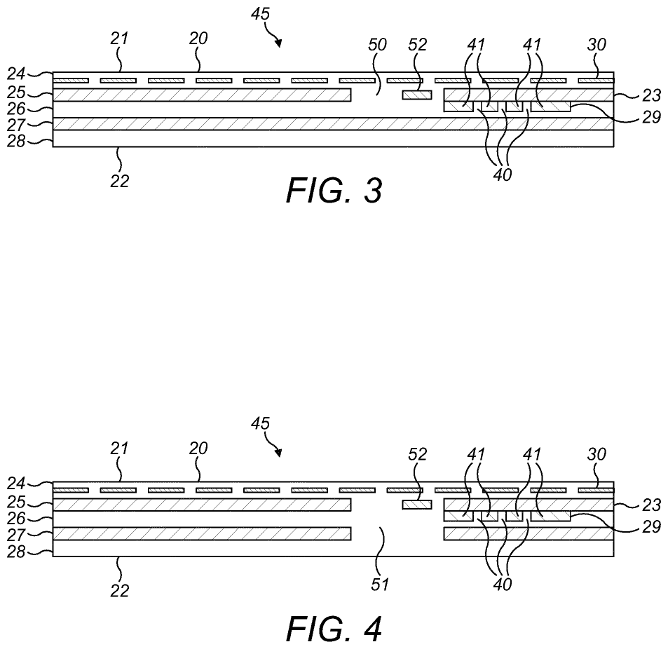

FIGS. 3 and 4 illustrate embodiments of the security sheet 45 comprising a window 50, 51 and formed in accordance with the method of the present invention. In FIG. 3, the window 50 is a half window 50 and comprises a transparent window region extending from the first outer surface 21 to the second concealing region 27. Hence, the second concealing region 27 is visible through the half window 50 from the first outer surface 21. The half window 50 may be formed by forming or cutting an aperture in the first opaque layer 13 and allowing transparent material from adjacent layers to enter the aperture or formed by inserting a transparent insert into an aperture through the first opaque layer 13 (and optionally through the adjacent transparent layers 10, 11, 12, 14, 15) prior to lamination.

In FIG. 4, the window is a full window 51 and comprises a transparent window region extending between the first and second outer surfaces 21, 22 and through the first and second concealing regions 25, 27. Hence it is possible to see through the entire plastic substrate 20 at the full window 51. The full window 50 may be formed by forming or cutting an aperture in the first opaque layer 13 and allowing transparent material from adjacent layers to enter the aperture or formed by inserting at least one transparent insert into apertures through the first and second opaque layers 13, 16 (and optionally through the adjacent transparent layers 10, 11, 12, 14, 15, 17, 18) prior to lamination.

In FIGS. 3 and 4, a further data element 52 is formed in the window 50, 51. For example, the further data element 52 may be formed by laser marking a laser markable portion of the transparent insert in line with the first concealing region 25 as illustrated. The further data element 52 is formed adjacent to the at least one data element 40 and so they together at least partially form personal data or non-variable data. For example, part of the text of a holder's name may be formed by the at least one further data element 52 and the rest of the text of the holder's name may be formed by the at least one data element 40. When viewed in transmitted and reflected light at the first outer surface 21, the full text of the holder's name may become visible. Alternatively, part of a single indicia, symbol, logo, image, or alphanumeric character may be formed by a data element 40 and the other part by a further data element 52 in the window 50, 51, the whole of the single indicia, symbol, logo, image, or alphanumeric character being visible in transmitted and reflected light.

1. A method of manufacturing a security sheet comprising a plastic substrate, wherein:
the plastic substrate comprises opposing first and second outer surfaces, a first concealing region extending between the first and second outer surfaces and a laser markable region at least partially located between the first concealing region and the second outer surface; and
the method comprises directing laser radiation from the first outer surface, through the first concealing region and onto the laser markable region to form at least one data element in the laser markable region such that the at least one data element is hidden from view by the first concealing region when the first outer surface is viewed by the naked eye in reflected light.

2. The method of claim 1, wherein the at least one data element is visible to the naked eye when the first outer surface is viewed in transmitted light.

3. The method of claim 1, wherein the plastic substrate comprises a second concealing region extending between the laser markable region and the second outer surface and wherein the at least one data element is hidden from view by the second concealing region when the second outer surface is viewed by the naked eye in reflected light.

4. The method of claim 1, wherein the optical density of the first concealing region is at least 0.4.

5. The method of claim 3, wherein the optical density of the second concealing region is at least 0.4.

6. The method of claim 1, wherein the laser markable region comprises at least one surrounding region(s) adjacent to, and darker or lighter than, at least one data element.

7. The method of claim 6, wherein the optical density of the security sheet when measured through the lighter of the at least one data element and/or surrounding region(s), from the first outer surface to the second outer surface, is less than 2.7.

8. The method of claim 6, wherein the difference in optical densities of the security sheet between the at least one data element and surrounding region(s), when measured therethrough from the first outer surface to the second outer surface, is at least 1.5, 1.6 or 1.7.

9. The method of claim 1, wherein the laser markable region extends partially across the first and/or second concealing region.

10. The method of claim 1, wherein the laser radiation changes the optical density of the laser markable region to form the at least one data element.

11. The method of claim 1, wherein the laser does not change the optical density of the first concealing region and/or the laser changes the optical density of the first concealing region by less than the laser changes the optical density of the laser markable region when forming the at least one data element.

12. The method of claim 1, wherein the laser marks, ablates or engraves the laser markable region to form the at least one data element in the laser markable region.

13. The method of claim 1, wherein the laser markable region comprises a metal layer, plastic and/or an ink layer.

14. The method of claim 1 further comprising directing the laser radiation from the first outer surface, through the first concealing region and onto the laser markable region to form at least one data element in the laser markable region and simultaneously at least one registered data element in the plastic substrate in register with the at least one data element.

15. The method of claim 14, wherein the plastic substrate comprises a first transparent region extending between the first outer surface and the first concealing region and the at least one registered data element is formed in the first transparent region.

16. The method of claim 1, wherein the plastic substrate comprises at least one window comprising a transparent window region extending through at least the first concealing region and the at least one data element is located adjacent to the at least one window.

17. (canceled)

18. The method of claim 1 further comprising forming the plastic substrate by laminating together a plurality of layers.

19. The method of claim 1, wherein the at least one data element forms personal data.

20. A method of manufacturing a plurality of security sheets, wherein each security sheet is formed in accordance with the method of claim 18 and further wherein the data elements form different personal data in the laser markable regions of the security sheets.

21. A security sheet comprising a plastic substrate, the plastic substrate comprising:
opposing first and second outer surfaces;
first and second concealing regions extending between the first and second outer surfaces;
a laser markable region at least partially located between the first and second concealing regions; and
at least one laser marked, ablated or engraved data element located in the laser markable region and between the first and second concealing regions,
wherein the at least one data element is hidden from view by the first concealing region when the first outer surface is viewed by the naked eye in reflected light and the at least one data element is hidden from view by the second concealing region when the second outer surface is viewed by the naked eye in reflected light.
